(19) United States
(12) Patent Application Publication
(10) Pub. No.: US 2023/0190040 A1
(43) Pub. Date: Jun. 22, 2023

(54) Combustion Powered Electricity Generating Assembly

(71) Applicant: Jason Hill, Exeter (CA)

(72) Inventor: Jason Hill, Exeter (CA)

(21) Appl. No.: 17/552,937

(22) Filed: Dec. 16, 2021

(51) Int. Cl. A47J 37/07; F23B 20/00

(52) U.S. Cl. CPC A47J 37/0704; A47J 37/0786; F23B 20/00; F24B 1/20

(57) ABSTRACT

A combustion powered electricity generating assembly for grilling and generating electricity includes a grill housing, which defines an interior space. A front opening positioned in a front face of the grill housing allows for positioning of combustible materials into the interior space. A front door is hingedly engaged to the grill housing and is positioned to selectively close the front opening. A thermoelectric generator engaged to a back face of the housing generates an electrical current due to a temperature differential between the grill housing and the ambient environment. A power storage module is operationally engaged to the thermoelectric generator so that the power storage module is charged by the electrical current. The power storage module can be engaged an electrical device to power the electrical device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electricity generating assemblies and more particularly pertains to a new electricity generating assembly for grilling and generating electricity. The present invention discloses an electricity generating assembly comprising a grill housing usable as fire pit, a grill, a smoker, and a stovetop, and is engaged to a thermoelectric generator. The thermoelectric generator and a set of solar panels are engaged to a battery

### (2) Description of Related Art Including Information Disclosed Under 37 CFR 1.97 and 1.98

The prior art relates to electricity generating assemblies, which may comprise combustion chambers engaged to thermoelectric generators and grilling grates. Prior art electricity generating assemblies also may comprise grills engaged to thermoelectric generators that power associated grilling accessories. What is lacking in the prior art is an electricity generating assembly comprising a grill housing usable as fire pit, a grill, a smoker, and a stovetop, and is engaged to a thermoelectric generator. The thermoelectric generator and a set of solar panels are engaged to a battery.

### BRIEF SUMMARY OF THE INVENTION

An embodiment of the disclosure meets the needs presented above by generally comprising a grill housing, which defines an interior space. A front opening is positioned in a front face of the grill housing and is configured to allow positioning of combustible materials into the interior space. A front door is hingedly engaged to the grill housing and is positioned to selectively close the front opening. A thermoelectric generator is engaged to a back face of the housing and is configured to generate an electrical current due to a temperature differential between the grill housing and the ambient environment. A power storage module is operationally engaged to the thermoelectric generator so that the power storage module is charged by the electrical current. The power storage module is configured to engage an electrical device to power the electrical device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a combustion powered electricity generating assembly according to an embodiment of the disclosure.

FIG. 2 is a front view of an embodiment of the disclosure.

FIG. 3 is a side view of an embodiment of the disclosure.

FIG. 4 is a rear view of an embodiment of the disclosure.

FIG. 5 is a detail view of an embodiment of the disclosure.

FIG. 6 is a detail view of an embodiment of the disclosure.

### DETAILED DESCRIPTION OF THE INVENTION

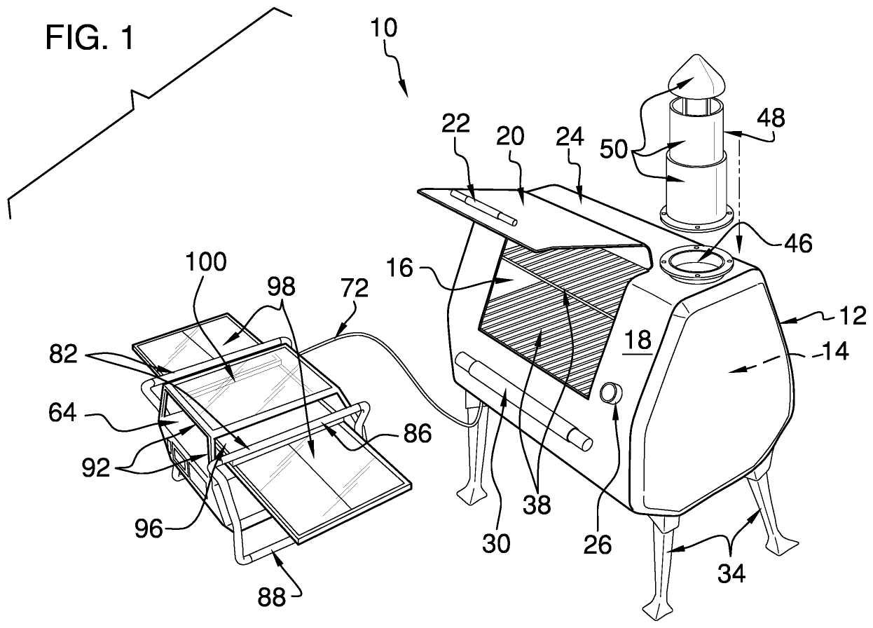

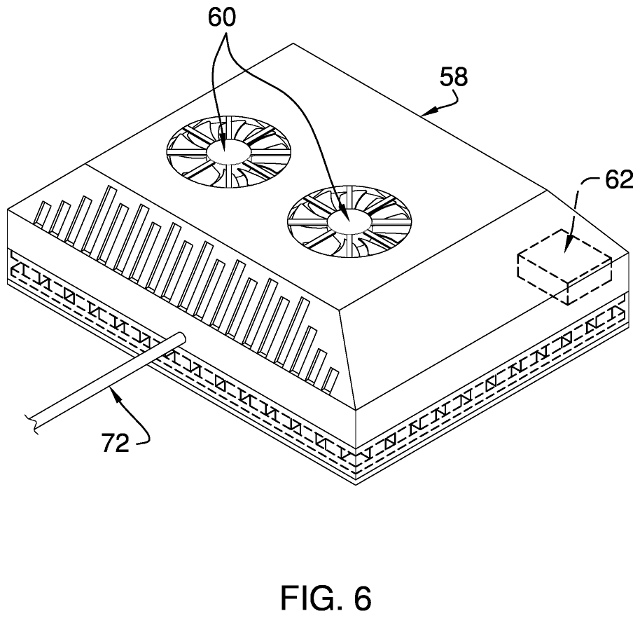

With reference now to the drawings, and in particular to FIGS. 1 through 6 thereof, a new electricity generating assembly embodying the principles and concepts of an embodiment of the disclosure and generally designated by the reference numeral 10 will be described.

As best illustrated in FIGS. 1 through 6, the combustion powered electricity generating assembly 10 generally comprises a grill housing 12, which defines an interior space 14. A front opening 16 is positioned in a front face 18 of the grill housing 12 and is configured to allow positioning of combustible materials, such as, but not limited to, wood, charcoal, and the like, into the interior space 14. A front door 20 is hingedly engaged to the grill housing 12 and is positioned to selectively close the front opening 16. A front handle 22 is engaged to the front door 20 and is configured to allow lifting of the front door 20. A top 24 of the grill housing 12 is flat and thus is configured for griddling.

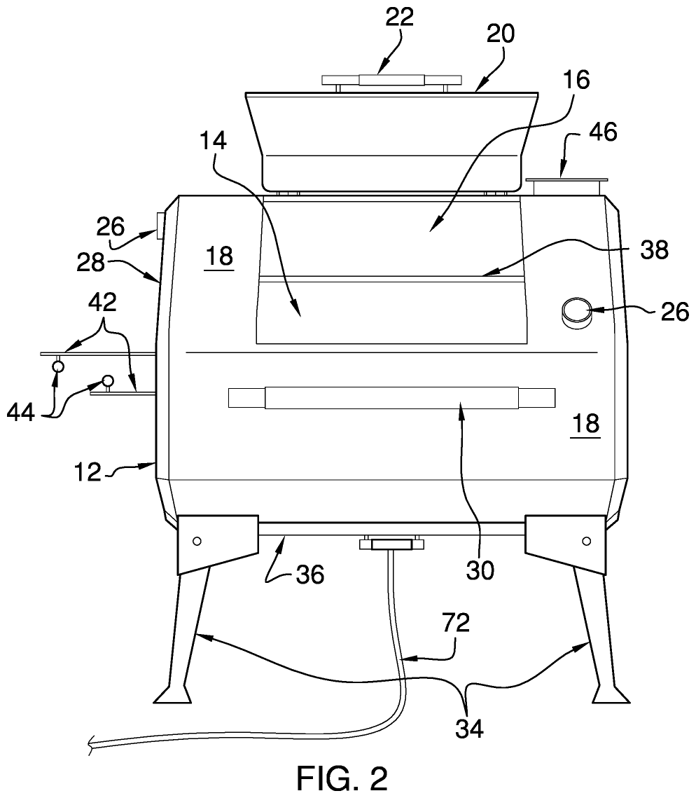

A gauge 26 is engaged to the grill housing 12 and is configured to present a temperature reading of the interior space 14. As shown in FIG. 2, the gauge 26 comprises a pair of gauges 26, one positioned on the front face 18 of the grill housing 12 the other positioned on a respective side face 28 of the grill housing 12 proximate to the top 24 of the grill housing 12.

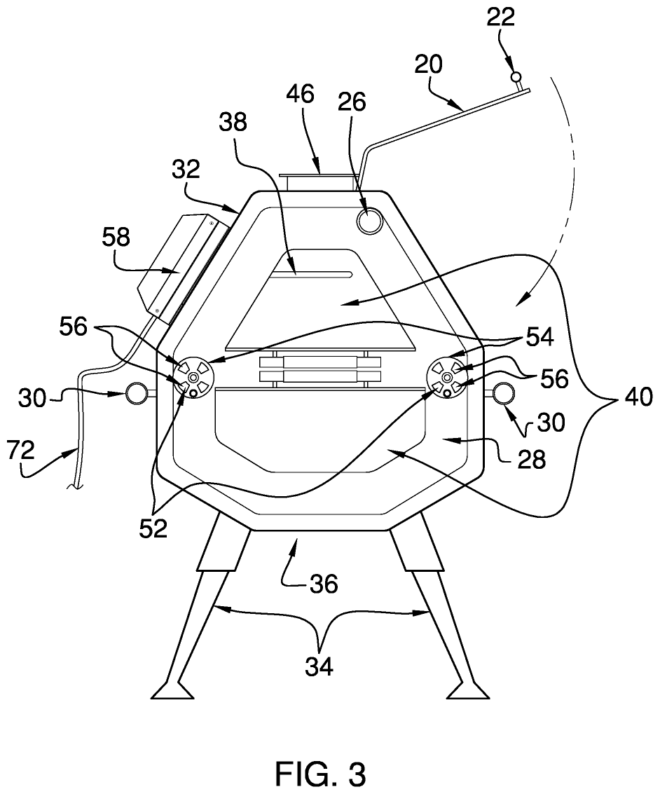

A pair of lift handles 30 is engaged to the grill housing 12. One lift handle 30 is engaged to the front face 18 of the grill housing 12 below the front opening 16. The other lift handle 30 is engaged to a back face 32 of the grill housing 12. The lift handles 30 are configured to allow the grill housing 12 to be lifted and positioned. The grill housing 12 may be sized similarly to a 55 gallon drum, so having the pair of lift handles 30 available renders it easier to lift and to position. The grill housing 12 may have an irregular octagon shape when viewed from a respective side face 28, as shown in FIG. 3.

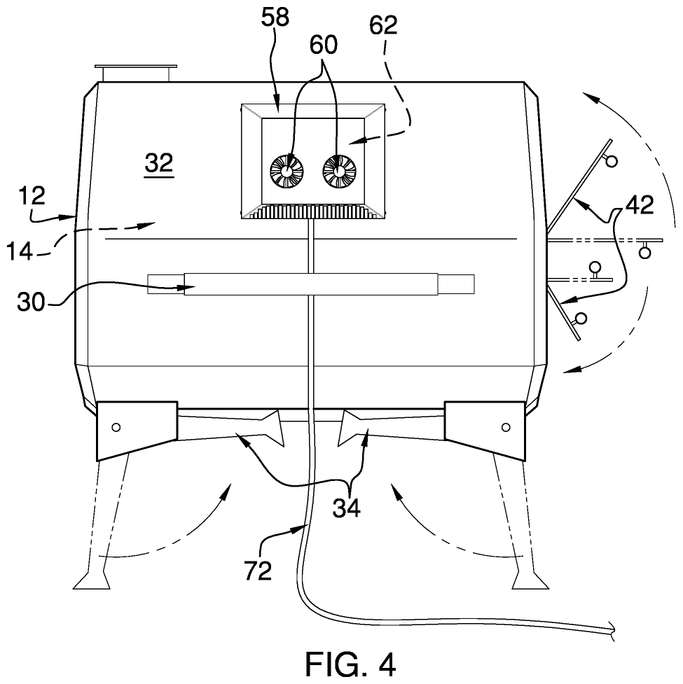

A plurality of legs 34 is engaged to and extends from a bottom 36 of the grill housing 12. The legs 34 are configured to support the grill housing 12 on a surface. The legs 34 may be hingedly engaged to the grill housing 12 so that the legs 34 are selectively positionable in a deployed configuration and a stowed configuration, as shown in FIG. 4. The legs 34 may be positioned in the deployed configuration when using the combustion powered electricity generating assembly 10 on a deck, in a backyard, or the like. Alternatively, the combustion powered electricity generating assembly 10 might be used with the legs 34 in the stowed configuration on sand.

A set of grates 38 is engaged to the grill housing 12 and is positioned in the interior space 14. The front opening 16 is configured to allow access to the interior space 14 to allow grilling of an item on a respective grate 38. The set of grates 38 may comprise two grates 38, as shown in FIG. 1, although the present invention also anticipates the set of grates 38 comprising one, three, or more grates 38.

Each of a plurality of side openings 40 is positioned in a respective side face 28 of the grill housing 12. The side opening 40 is configured to allow access to the interior space 14 from the respective side face 28. The plurality of side openings 40 may comprise two side openings 40, which are positioned in a respective side face 28 of the grill housing 12, as shown in FIG. 3. Each of a plurality of side doors 42 is hingedly engaged to the grill housing 12, proximate to a respective side opening 40, so that the side door 42 is positioned to selectively close the respective side opening 40. Each of a plurality of side handles 44 is engaged to a respective side door 42 and is configured to allow lifting of the respective side door 42.

An aperture 46 is positioned in the top 24 of the grill housing 12. A smokestack 48 is engaged to the top 24 of the grill housing 12 and extends from the aperture 46. The smokestack 48 is configured to vent the interior space 14. The smokestack 48 may be selectively engageable to the grill housing 12, as shown in FIG. 1. The smokestack 48 may comprise a plurality of nested sections 50 so that the smokestack 48 is selectively extensible.

A plurality of sets of vent holes 52 is positioned in the grill housing 12. The sets of vent holes 52 are configured to vent the interior space 14. The plurality of sets of vent holes 52 may comprise two sets of vent holes 52 positioned in a respective side face 28 of the grill housing 12, as shown in FIG. 3. Each of a plurality of dampers 54 is rotationally engaged to the grill housing 12 over a respective set of vent holes 52. Cutouts 56 in the damper 54 are selectively alignable with the vent holes 52 of the respective set of vent holes 52 to vent the interior space 14.

A thermoelectric generator 58 is engaged to the back face 32 of the housing and is configured to generate an electrical current due to a temperature differential between the grill housing 12 and the ambient environment. The thermoelectric generator 58 may be selectively engageable to the back face 32 of the grill housing 12 so that the thermoelectric generator 58 is removable from the grill housing 12. A pair of fans 60 is engaged to the thermoelectric generator 58 so that the fans 60 are positioned to cool the thermoelectric generator 58. A controller 62 is operationally engaged to the thermoelectric generator 58 and to the pair of fans 60. The controller 62 is enabled to selectively actuate the pair of fans 60 to cool the thermoelectric generator 58.

A power storage module 64 is operationally engaged to the thermoelectric generator 58 so that the power storage module 64 is charged by the electrical current. The power storage module 64 is configured to engage an electrical device, such as a phone, audio or audiovisual equipment, and the like, to power the electrical device. The combustion powered electricity generating assembly 10 thus provides a means of grilling, griddling, heating, smoking, and generating electricity. It thus is anticipated to be useful in a variety of settings where access to electricity is not available.

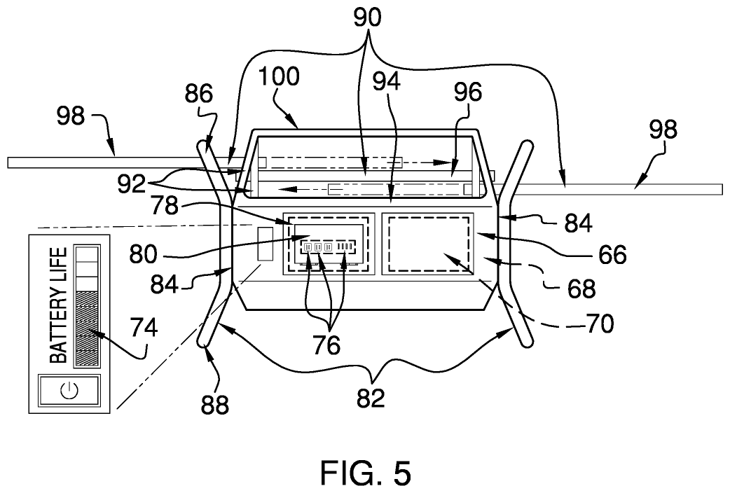

The power storage module 64 comprises a module housing 66, which defines an internal space 68. A battery 70 is engaged to the module housing 66 and is positioned in the internal space 68, as shown in FIG. 5. A power cable 72 is engaged to and extends between the thermoelectric generator 58 and the battery 70. An indicator 74 is engaged to the module housing 66 and is operationally engaged to the battery 70. The indicator 74 is able to indicate a charge state of the battery 70. A set of outlets 76 is engaged to the module housing 66 and is operationally engaged to the battery 70. A respective outlet 76 is configured for insertion of a plug of a power cord of the electrical device. The present invention anticipates the set of outlets 76 comprising Type A receptacles, Type B receptacles, Universal Serial Bus ports, and the like.

A recess 78 is positioned in the module housing 66. The set of outlets 76 is positioned in the recess 78. A lid 80 is hingedly engaged to the module housing 66 and is positioned to selectively cover the recess 78, thus shielding the outlets 76 from the elements. The rings 82 of a pair of rings 82 are engaged singly to opposed ends 84 of the module housing 66. Each ring 82 is formed to define a grasp 86, which extends upwardly from the module housing 66, and a footing 88, which extends downwardly from the module housing 66.

A set of solar panels 90 is engaged to the module housing 66 and is operationally engaged to the battery 70. The solar panels 90 are configured to convert electromagnetic radiation to an electrical current to charge the battery 70. A frame 92 is engaged to and extends from an upper facet 94 of the module housing 66. As shown in FIG. 5, the set of solar panels 90 comprises a first panel 96 and a pair of second panels 98. The first panel 96 is fixedly engaged to the frame 92. The second panels 98 are slidably engaged to the frame 92 so that each second panel 98 is selectively slidable from the frame 92 past a respective opposed end 84 of the module housing 66. A shield panel 100 is engaged to the frame 92 distal from the module housing 66. The shield panel 100, which comprises plexiglass, polycarbonate, or the like, is substantially transparent. The shield panel 100 is configured to protect the set of solar panels 90, when the solar panels 90 are positioned within the frame 92, and to allow passage of electromagnetic radiation.

In use, the grill housing 12 is carried using the pair of lift handles 30 to a desired location. The legs 34 are deployed and the grill housing 12 is positioned as desired. The thermoelectric generator 58 is engaged to the back face 32 of the grill housing 12 and the second panels 98 are extended from the frame 92, positioning the thermoelectric generator 58 and the solar panels 90 to charge the battery 70. Combustible materials are positioned in the interior space 14 and ignited. As the grill housing 12 and interior space 14 are heated, foods can be positioned on the grates 38 and the top 24 of the grill housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combustion powered electricity generating assembly comprising:
a grill housing defining an interior space;
a front opening positioned in a front face of the grill housing, wherein the front opening is configured for positioning of combustible materials into the interior space;
a front door hingedly engaged to the grill housing, such that the front door is positioned for selectively closing the front opening;
a thermoelectric generator engaged to a back face of the housing, wherein the thermoelectric generator is configured for generating an electrical current due to a temperature differential between the grill housing and the ambient environment; and
a power storage module operationally engaged to the thermoelectric generator and being configured for engaging an electrical device, such that the power storage module is charged by the electrical current, wherein the power storage module is configured for powering the electrical device.

2. The combustion powered electricity generating assembly of claim 1, further including a top of the grill housing being flat, wherein the top is configured for griddling.

3. The combustion powered electricity generating assembly of claim 1, further including:
a pair of lift handles engaged to the grill housing, one lift handle being engaged to the front face of the grill housing below the front opening, the other lift handle being engaged to the back face of the grill housing, wherein the lift handles are configured for lifting and positioning of the grill housing; and
a front handle engaged to the front door, wherein the front handle is configured for lifting of the front door.

4. The combustion powered electricity generating assembly of claim 1, further including a plurality of legs engaged to and extending from a bottom of the grill housing, wherein the legs are configured for supporting the grill housing on a surface, the legs being hingedly engaged to the grill housing, such that the legs are selectively positionable in a deployed configuration and a stowed configuration.

5. The combustion powered electricity generating assembly of claim 1, further including a set of grates engaged to the grill housing and positioned in the interior space, wherein the front opening is configured for accessing the interior space for grilling an item on a respective grate.

6. The combustion powered electricity generating assembly of claim 1, further including:
a pair of fans engaged to the thermoelectric generator, such that the fans are positioned for cooling the thermoelectric generator; and
a controller operationally engaged to the thermoelectric generator and the pair of fans, such that the controller is enabled for selectively actuating the pair of fans for cooling the thermoelectric generator.

7. The combustion powered electricity generating assembly of claim 1, further including:
the thermoelectric generator being selectively engageable to the back face of the grill housing, such that the thermoelectric generator is removable from the grill housing;
the power storage module comprising:
a module housing defining an internal space,
a battery engaged to the module housing and positioned in the internal space,
a set of outlets engaged to the module housing and operationally engaged to the battery, wherein a respective outlet is configured for insertion of a plug of a power cord of the electrical device, and
an indicator engaged to the module housing and operationally engaged to the battery, such that the indicator is enabled for indicating a charge state of the battery; and
a power cable engaged to and extending between the thermoelectric generator and the battery.

8. The combustion powered electricity generating assembly of claim 7, further including:
a recess positioned in the module housing, the set of outlets being positioned in the recess; and
a lid hingedly engaged to the module housing, such that the lid is positioned for selectively covering the recess for shielding the outlets from the elements.

9. The combustion powered electricity generating assembly of claim 7, further including a pair of rings engaged singly to opposed ends of the module housing, each ring being formed to define a grasp extending upwardly from the module housing and a footing extending downwardly from the module housing.

10. The combustion powered electricity generating assembly of claim 7, further including a set of solar panels engaged to the module housing and operationally engaged to the battery, wherein the solar panels are configured for converting electromagnetic radiation to an electrical current for charging the battery.

11. The combustion powered electricity generating assembly of claim 10, further including:
a frame engaged to and extending from an upper facet of the module housing;
the set of solar panels comprising:
a first panel fixedly engaged to the frame, and
a pair of second panels slidably engaged to the frame, such that each second panel is selectively slidable from the frame past a respective opposed end of the module housing; and
a shield panel engaged to the frame distal from the module housing, the shield panel being substantially transparent, wherein the shield panel is configured for protecting the set of solar panels positioned within the frame and for passage of electromagnetic radiation.

12. The combustion powered electricity generating assembly of claim 1, further including:
a plurality of side openings, each side opening being positioned in a respective side face of the grill housing, wherein the side opening is configured for accessing the interior space; and
a plurality of side doors, each side door being hingedly engaged to the grill housing proximate to a respective side opening, such that the side door is positioned for selectively closing the respective side opening.

13. The combustion powered electricity generating assembly of claim 12, further including:
the plurality of side openings comprising two side openings positioned in a respective side face of the grill housing; and
a plurality of side handles, each side handle being engaged to a respective side door, wherein the side handle is configured for lifting of the respective side door.

14. The combustion powered electricity generating assembly of claim 1, further including a gauge engaged to the grill housing and being configured for presenting a temperature reading of the interior space.

15. The combustion powered electricity generating assembly of claim 1, further including:
an aperture positioned in the top of the grill housing; and
a smokestack engaged to the top of the grill housing and extending from the aperture, wherein the smokestack is configured for venting the interior space.

16. The combustion powered electricity generating assembly of claim 15, wherein:
the smokestack is selectively engageable to the grill housing; and
the smokestack comprise a plurality of nested sections, such that the smokestack is selectively extensible.

17. The combustion powered electricity generating assembly of claim 1, further including:
a plurality of sets of vent holes positioned in the grill housing, wherein the sets of vent holes are configured for venting the interior space; and
a plurality of dampers, each damper being rotationally engaged to the grill housing over a respective set of vent holes, such that cutouts in the damper are selectively alignable with the vent holes of the respective set of vent holes for venting the interior space.

18. The combustion powered electricity generating assembly of claim 17, further including the plurality of sets of vent holes comprising two sets of vent holes positioned in a respective side face of the grill housing.

19. A combustion powered electricity generating assembly comprising:
a grill housing defining an interior space, a top of the grill housing being flat, wherein the top is configured for griddling;
a pair of lift handles engaged to the grill housing, one lift handle being engaged to a front face of the grill housing below the front opening, the other lift handle being engaged to a back face of the grill housing, wherein the lift handles are configured for lifting and positioning of the grill housing;
a plurality of legs engaged to and extending from a bottom of the grill housing, wherein the legs are configured for supporting the grill housing on a surface, the legs being hingedly engaged to the grill housing, such that the legs are selectively positionable in a deployed configuration and a stowed configuration;
a front opening positioned in the front face of the grill housing, wherein the front opening is configured for positioning of combustible materials into the interior space;
a front door hingedly engaged to the grill housing, such that the front door is positioned for selectively closing the front opening;
a front handle engaged to the front door, wherein the front handle is configured for lifting of the front door;
a set of grates engaged to the grill housing and positioned in the interior space, wherein the front opening is configured for accessing the interior space for grilling an item on a respective grate;
a thermoelectric generator engaged to the back face of the housing, wherein the thermoelectric generator is configured for generating an electrical current due to a temperature differential between the grill housing and the ambient environment;
a pair of fans engaged to the thermoelectric generator, such that the fans are positioned for cooling the thermoelectric generator;
a controller operationally engaged to the thermoelectric generator and the pair of fans, such that the controller is enabled for selectively actuating the pair of fans for cooling the thermoelectric generator;
a power storage module operationally engaged to the thermoelectric generator and being configured for engaging an electrical device, such that the power storage module is charged by the electrical current, wherein the power storage module is configured for powering the electrical device, the thermoelectric generator being selectively engageable to the back face of the grill housing, such that the thermoelectric generator is removable from the grill housing, the power storage module comprising:
a module housing defining an internal space,
a battery engaged to the module housing and positioned in the internal space,
an indicator engaged to the module housing and operationally engaged to the battery, such that the indicator is enabled for indicating a charge state of the battery,
a set of outlets engaged to the module housing and operationally engaged to the battery, wherein a respective outlet is configured for insertion of a plug of a power cord of the electrical device;
a recess positioned in the module housing, the set of outlets being positioned in the recess,
a lid hingedly engaged to the module housing, such that the lid is positioned for selectively covering the recess for shielding the outlets from the elements, and
a pair of rings engaged singly to opposed ends of the module housing, each ring being formed to define a grasp extending upwardly from the module housing and a footing extending downwardly from the module housing;
a frame engaged to and extending from an upper facet of the module housing;
a power cable engaged to and extending between the thermoelectric generator and the battery;
a set of solar panels engaged to the module housing and operationally engaged to the battery, wherein the solar panels are configured for converting electromagnetic radiation to an electrical current for charging the battery, the set of solar panels comprising:
a first panel fixedly engaged to the frame, and
a pair of second panels slidably engaged to the frame, such that each second panel is selectively slidable from the frame past a respective opposed end of the module housing;
a shield panel engaged to the frame distal from the module housing, the shield panel being substantially transparent, wherein the shield panel is configured for protecting the set of solar panels positioned within the frame and for passage of electromagnetic radiation;
a plurality of side openings, each side opening being positioned in a respective side face of the grill housing, wherein the side opening is configured for accessing the interior space, the plurality of side openings comprising two side openings positioned in a respective side face of the grill housing;
a plurality of side doors, each side door being hingedly engaged to the grill housing proximate to a respective side opening, such that the side door is positioned for selectively closing the respective side opening;
a plurality of side handles, each side handle being engaged to a respective side door, wherein the side handle is configured for lifting of the respective side door;
a gauge engaged to the grill housing and being configured for presenting a temperature reading of the interior space;
an aperture positioned in the top of the grill housing;
a smokestack engaged to the top of the grill housing and extending from the aperture, wherein the smokestack is configured for venting the interior space, the smokestack being selectively engageable to the grill housing, the smokestack comprising a plurality of nested sections, such that the smokestack is selectively extensible;
a plurality of sets of vent holes positioned in the grill housing, wherein the sets of vent holes are configured for venting the interior space, the plurality of sets of vent holes comprising two sets of vent holes positioned in a respective side face of the grill housing; and
a plurality of dampers, each damper being rotationally engaged to the grill housing over a respective set of vent holes, such that cutouts in the damper are selectively alignable with the vent holes of the respective set of vent holes for venting the interior space.
